(19) United States
(12) Patent Application Publication
(10) Pub. No.: US 2024/0185586 A1
(43) Pub. Date: Jun. 6, 2024

(54) OBJECT DETECTION MODELS ADJUSTMENTS

(71) Applicant: Hewlett-Packard Development Company, L.P., Spring, TX (US)

(72) Inventors: Hong-Wei Chou, Taipei City (TW); Pei-Yuan Chien, Taipei City (TW); Peter Siyuan Zhang, Taipei City (TW)

(73) Assignee: Hewlett-Packard Development Company, L.P., Spring, TX (US)

(21) Appl. No.: 18/550,528

(22) PCT Filed: Apr. 13, 2021
(86) PCT No.: PCT/US2021/027033

§ 371 Date: Sep. 14, 2023

(51) Int. Cl. G06V 10/776; G06V 10/74; G06V 10/771; G06V 10/80

(52) U.S. Cl. CPC G06V 10/776; G06V 10/761; G06V 10/771; G06V 10/80

(57) ABSTRACT

Examples of electronic devices are described herein. In some examples, an electronic device includes a processor to generate an evaluation image dataset to determine precision of a machine learning object detection model. In some examples, the processor is to run the evaluation image dataset on the object detection model to identify a misdetection region in the evaluation image dataset. In some examples, the processor is to generate a training image dataset to adjust the object detection model based on the identified misdetection region.

### BACKGROUND

Electronic technology has advanced to become virtually ubiquitous in society and has been used to improve many activities in society. For example, electronic devices are used to perform a variety of tasks, including work activities, communication, research, and entertainment. Different varieties of electronic circuits may be utilized to provide different varieties of electronic technology.

### BRIEF DESCRIPTION OF THE DRAWINGS

Various examples will be described below by referring to the following figures.

FIG. 1 is a block diagram illustrating an example of an electronic device to perform object detection model evaluation and adjustment;

FIG. 2 illustrates an example of a background image divided into a grid for an evaluation image dataset and training image dataset;

FIG. 3 illustrates an example of an evaluation image dataset;

FIG. 4 flow diagram illustrating an example of a method for object detection model evaluation and adjustment;

FIG. 5 is a flow diagram illustrating another example of a method for object detection model evaluation and adjustment;

FIG. 6 is a flow diagram illustrating an example of a method for generating an evaluation image dataset;

FIG. 7 is a flow diagram illustrating an example of a method for evaluating an object detection model;

FIG. 8 is a flow diagram illustrating an example of a method for generating a training image dataset; and

FIG. 9 is a block diagram illustrating an example of a computer-readable medium for object detection model evaluation and adjustment.

Throughout the drawings, identical or similar reference numbers may designate similar, but not necessarily identical, elements. The figures are not necessarily to scale, and the size of some parts may be exaggerated to more clearly illustrate the example shown. Moreover, the drawings provide examples in accordance with the description; however, the description is not limited to the examples provided in the drawings.

### DETAILED DESCRIPTION

An electronic device may be a device that includes electronic circuitry. For instance, an electronic device may include integrated circuitry (e.g., transistors, digital logic, semiconductor technology, etc.). Examples of electronic devices include computing devices, laptop computers, desktop computers, smartphones, tablet devices, wireless communication devices, cameras, game consoles, game controllers, smart appliances, printing devices, vehicles with electronic components, aircraft, drones, robots, etc.

In some examples, the electronic device may perform object detection. For example, the electronic device may include a neural network that runs an object detection model. The object detection model may be trained to detect an object in images. In some examples, the electronic device may perform an operation based on the object detection. In some examples, the electronic device may apply security settings (e.g., security screens) based on a detected object. In some examples, the electronic device may change performance settings (e.g., power usage, CPU speed, display brightness, speaker levels, etc.) based on the detected object. In some examples, the electronic device may issue a command to another device to perform an operation based on the detected object.

In some examples, the electronic device may detect a target object based on captured images. For example, the electronic device may include a camera to capture images. The electronic device may detect objects based on the captured images.

In some examples, object detection is a computer vision technique used in artificial intelligence (AI) use cases. In some example approaches, an object detection model may be trained and tuned to fit a given user scenario or use case.

In an approach, evaluation metrics such as mean Average Precision (mAP) may be used for object detection. The mAP evaluation metrics may provide an objective and general view of the performance of an object detection model. However, the mAP evaluation metrics may lack complete information to determine the performance of the object detection model for its intended purpose.

In some examples, the locations and size of a target object in an image may affect the performance of the object detection model. As used herein, a target object is an object that the object detection model is trained to detect. When a target object is located in certain locations (referred to as regions) of an image, the performance of the object detection model may be worse than when the target object is located in other regions of the image. In this case, the electronic device may misdetect the presence of a target object. As used herein, misdetection may include a false positive detection of a target object (i.e., a false positive detection) and/or a failed detection of a target object (i.e., a false negative detection).

The misdetection of the target object in a given region of an image may be referred to as a blind spot in the object detection model. As used herein, the region of an image in which the object detection model fails to accurately detect a target object is referred to as a misdetection region. In other words, a misdetection region may be an area of an image where detection performance of the object detection model is relatively worse (e.g., worse than a threshold amount) than the overall performance of the object detection model. In some examples the target object may frequently appear in the misdetection region. However, this weakness may be undetected by a validation dataset that checks the precision, recall, and mAP of the object detection model if the validation dataset lacks variety in the target object location and size. Thus, a blind spot in the object detection model may result in a negative user experience and/or inaccurate performance of the electronic device.

To improve the detection performance, a new set of training data may be manually generated with ground truth labeling that is able to effectively adjust the object detection model. Examples described herein may automatically generate training datasets in accordance with the evaluation results.

These examples include a systematic approach to generate evaluation image datasets to determine whether the performance of an object detection model has dependency on the object location and size of the object in an image. In some examples, an evaluation image dataset may be generated to identify a misdetection region. The evaluation image dataset may be generated in an organized manner to find weak spots of an object detection model.

A corresponding training image dataset may be generated to adjust the performance of the object detection model. In some examples, the generated training image dataset may include images with the target object placed at the misdetection region (e.g., the weak spots of the object detection model). The object detection model may be trained using the training image dataset to better detect the target object in the misdetection region. In some examples, the object detection model may be trained with the training image dataset using transfer learning. In some examples, because the performance of the object detection model is evaluated by the evaluation image dataset, images from the evaluation image dataset that include the target object in the misdetection region may be used as the training image dataset. In some examples, a new training image dataset may be generated based on the conclusion of evaluation results to effectively improve the object detection model performance. Examples of object detection model evaluation and adjustment are now described in more detail.

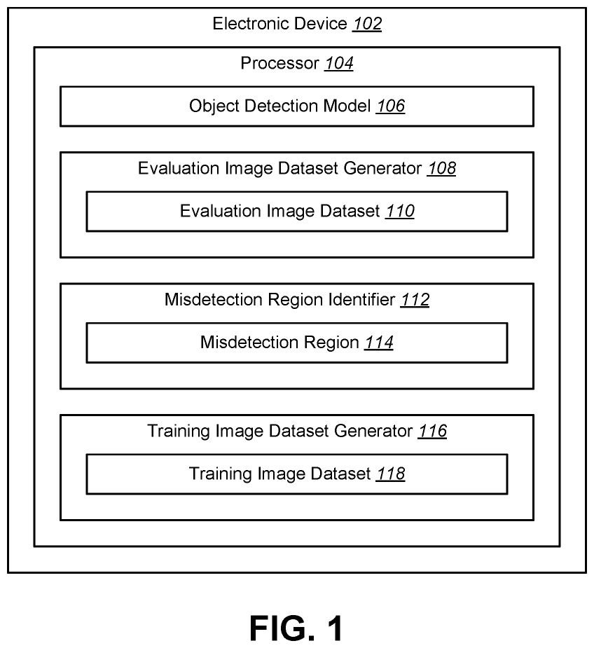

FIG. 1 is a block diagram illustrating an example of an electronic device 102 to perform object detection model evaluation and adjustment. Examples of the electronic device 102 may include computing devices, laptop computers, desktop computers, tablet devices, cellular phones, smartphones, wireless communication devices, cameras, gaming consoles, gaming controllers, smart appliances, printing devices, automated teller machines (ATMs), vehicles (e.g., automobiles) with electronic components, autonomous vehicles, aircraft, drones, robots, etc.

In some examples, the electronic device 102 may include a processor 104. The processor 104 may be any of a microcontroller (e.g., embedded controller), a central processing unit (CPU), a semiconductor-based microprocessor, graphics processing unit (GPU), field-programmable gate array (FPGA), an application-specific integrated circuit (ASIC), a circuit, a chipset, and/or other hardware device suitable for retrieval and execution of instructions stored in a memory (not shown). The processor 104 may fetch, decode, and/or execute instructions stored in memory. While a single processor 104 is shown in FIG. 1, in other examples, the processor 104 may include multiple processors (e.g., a CPU and a GPU).

The memory of the electronic device 102 may be any electronic, magnetic, optical, and/or other physical storage device that contains or stores electronic information (e.g., instructions and/or data). The memory may be, for example, Random Access Memory (RAM), Electrically Erasable Programmable Read-Only Memory (EEPROM), Dynamic Random Access Memory (DRAM), Synchronous DRAM (SDRAM), magnetoresistive random-access memory (MRAM), phase change RAM (PCRAM), non-volatile random-access memory (NVRAM), memristor, flash memory, a storage device, and/or an optical disc, etc. In some examples, the memory may be a non-transitory tangible computer-readable storage medium, where the term “non-transitory” does not encompass transitory propagating signals. The processor 104 may be in electronic communication with the memory. In some examples, a processor 104 and/or memory of the electronic device 102 may be combined with or separate from a processor (e.g., CPU) and/or memory of a host device.

In some examples, the processor 104 may implement an object detection model 106. In some examples, the object detection model 106 may be a machine learning model that is trained to detect an object in an image. Some examples of a machine learning model include neural networks such as convolutional neural networks (CNNs) (e.g., basic CNN, R-CNN, inception model, residual neural network, etc.).

In some examples, the object detection model 106 may be trained to detect a target object in an image using training images. Examples of a target object include a human face and/or human body (e.g., head, torso, legs, arms, etc.). In some examples, the target object may include non-human objects such as animals, road signs, recording devices (e.g., smartphones, cameras, etc.), vehicles (e.g., automobiles, airplanes, helicopters, drones, etc.), robots, fabricated parts, etc.

An evaluation image dataset 110 may be generated to evaluate the performance of the object detection model 106. For example, the processor 104 may implement an evaluation image dataset generator 108 to generate an evaluation image dataset 110. In some examples, the evaluation image dataset 110 may be used to determine the precision of the machine learning object detection model 106. For example, the evaluation image dataset 110 may be used to determine whether the object detection model 106 accurately detects a target object in different locations of an image. In other examples, the evaluation image dataset 110 may be used to determine whether the object detection model 106 accurately detects a target object with different sizes.

The evaluation image dataset 110 may include a number of images that depict a target object in various positions within the images. The target object may also be depicted with different orientations, poses and/or sizes in the evaluation image dataset 110.

In some examples, the evaluation image dataset generator 108 may select a background image. For example, the evaluation image dataset generator 108 may select a solid color (e.g., grey, white, black, etc.) or an image for the background of the evaluation image dataset 110.

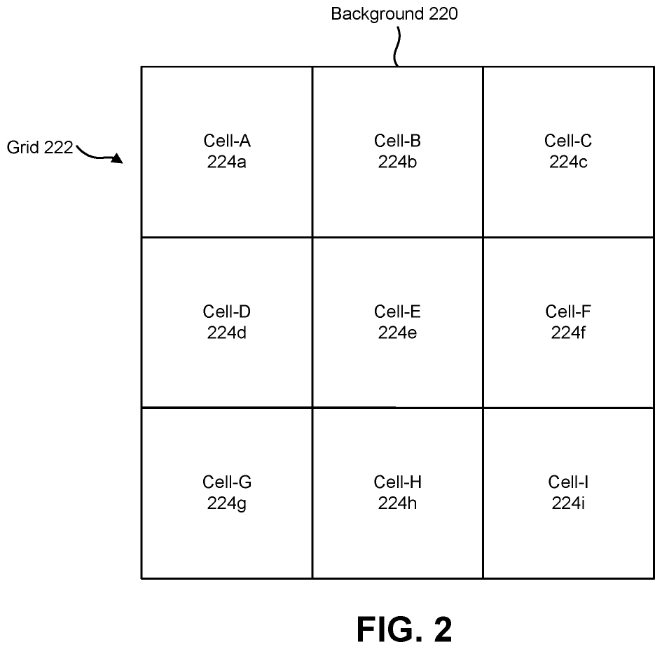

In some examples, the evaluation image dataset generator 108 may divide the background image into a grid. For example, the grid may be an NxM grid, where N is a number of rows and M is a number of columns. For example, the background image may be divided into a 3×3 grid. An example of a background image divided into a grid is described in FIG. 2.

Referring briefly to FIG. 2, a background 220 may be selected. In some examples, the background 220 may be a solid color (e.g., red, green, blue, gray, black, white, etc.). In some examples, the background 220 may be an image (e.g., an image of a scene).

In this example, the background 220 is divided into a 3×3 grid 222. A first row of the grid 222 includes three cells (i.e., cell-A 224a, cell-B 224b, and cell-C 224c). A second row of the grid 222 includes three cells (i.e., cell-D 224d, cell-E 224e, and cell-F 224f). A third row of the grid 222 also includes three cells (i.e., cell-G 224g, cell-H 224h, and cell-I 224i).

In some examples, the dimensions of the rows of the grid 222 may be equal. For instance, the height of the rows may be equal. Furthermore, the dimensions of the columns of the grid 222 may be equal. For instance, the width of the columns may be equal.

In some examples, the dimensions of the rows of the grid 222 may differ. For instance, the height of a row may differ from the height of other rows. Furthermore, the dimensions of the columns of the grid 222 may differ. For instance, the width of a column may differ from the width of another column.

Referring again to FIG. 1, in some examples, the evaluation image dataset generator 108 may select a target object. For example, the target object may be selected based on the type of object detection that is performed by the object detection model 106. For instance, if the object detection model 106 is used for detecting human faces, then the evaluation image dataset generator 108 may select an image of a human face as the target object. In some examples, different types of images may be selected corresponding to the type of object detection performed by the object detection model 106.

In some examples, the evaluation image dataset generator 108 may size a target object to fit within a cell of the grid. For example, a selected target object (e.g., an image of an object) may be resized to fit the dimensions (e.g., height and width) of a grid cell.

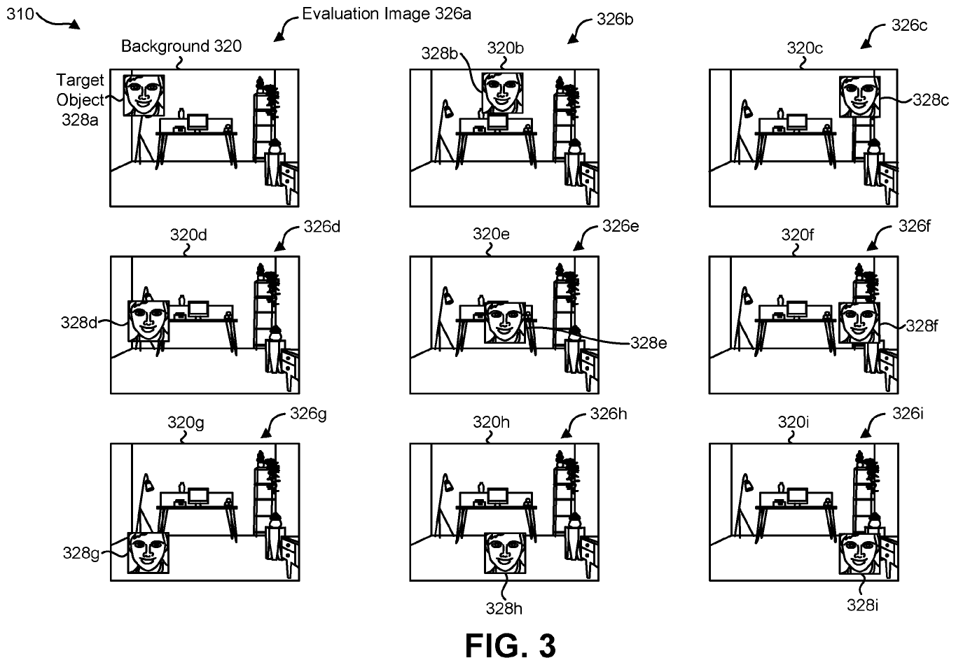

The evaluation image dataset generator 108 may generate a number of images by placing the target object into the cells. In some examples, the evaluation image dataset generator 108 may place a single instance of the target object in a given cell. An example of this process is described in FIG. 3.

Referring briefly to FIG. 3, an example of an evaluation image dataset 310 is illustrated. In this example, a background image is divided into a 3×3 grid, as described in FIG. 2. In this example, there are nine evaluation images 326a-i corresponding to the nine cells of the 3×3 grid.

For a first evaluation image 326a in the evaluation image dataset 310, a target object 328a is positioned in a first cell located in the top left corner of the background 320. A second evaluation image 326b has the target object 328b positioned in a second cell located in the top center of the background 320b. A third evaluation image 326c has the target object 328c positioned in a third cell located in the top right corner of the background 320c. A fourth evaluation image 326d has the target object 328d positioned in a fourth cell located in the middle left of the background 320d. A fifth evaluation image 326e has the target object 328e positioned in a fifth cell located in the middle of the background 320e. A sixth evaluation image 326f has the target object 328f positioned in a sixth cell located in the middle right of the background 320f. A seventh evaluation image 326g has the target object 328g positioned in a seventh cell located in the bottom left corner of the background 320g. An eighth evaluation image 326h has the target object 328h positioned in an eighth cell located in the bottom middle of the background 320h. A ninth evaluation image 326i has the target object 328i positioned in a ninth cell located in the bottom right corner of the background 320i. It should be noted that in this example, a given evaluation image (e.g., evaluation image 326a) includes a single target object (e.g., target object 328a). In this example, the same target object may be used for each of the evaluation images 326a-i. In some examples (not shown) multiple target objects may be included in different cells of a given evaluation image. Therefore, the evaluation image dataset 310 may include multiple images (e.g., evaluation images 326a-i) with the target object placed in a different cell of the grid for each of the multiple images.

Referring again to FIG. 1, in some examples, upon placing the target object in different cells of the background, the evaluation image dataset generator 108 may render a different image for each of the target object placements. For example, the evaluation image dataset generator 108 may generate a unique image with a target object positioned within a given grid cell. The evaluation image dataset generator 108 may generate different images by placing the target object in different cells of the background.

In some examples, the evaluation image dataset 110 may include multiple subsets of images with different target objects placed in the grid on the background. For example a first subset of images may include a first target object positioned in the cells of the grid, as described in FIG. 3. A second subset of images may include a second target object positioned in the cells of the grid, a third subset of images may include a third target object positioned in the cells of the grid and so forth. In some examples, the subset of images in the evaluation image dataset 110 may vary the image used for the target object. In some examples, the subset of images in the evaluation image dataset 110 may vary the size of the target object.

In some examples, the processor 104 may implement a misdetection region identifier 112 to identify a misdetection region 114 in the evaluation image dataset 110. For example, the misdetection region identifier 112 may run the evaluation image dataset 110 on the object detection model 106. This may include providing the evaluation image dataset 110 to the object detection model 106 to determine whether the object detection model 106 accurately identifies the target object in the evaluation image dataset 110.

If the object detection model 106 fails to accurately detect the target object in the evaluation image dataset 110, then the location (e.g., cell) of the target object may be a misdetection region 114. As used herein, a misdetection region 114 may be defined as a portion of the evaluation image dataset 110 in which the object detection model 106 fails to accurately detect a target object. This failure to detect the target object may indicate a weakness (e.g., a blind spot) in the object detection model 106.

In some examples, the misdetection region 114 may be determined based on statistics of object detection for the different locations of the target object in the evaluation image dataset 110. In some examples, each grid cell may be given an accuracy score (Xᵢ) based on the number of times that the object detection model 106 accurately detects a target object, where i is the index for a given grid cell. For example, if the object detection model 106 accurately detects the target object seven times in a given grid cell when presented ten images, then the accuracy score (Xᵢ) for the given grid cell is 7/10 or 0.7.

It should be noted that because the electronic device 102 generates the evaluation image dataset 110, the electronic device 102 may know the ground truth of the target object. For example, the evaluation image dataset generator 108 may record the location of the target object and/or a bounding box surrounding the target object as metadata of a given image in the evaluation image dataset 110. This ground truth data may be used by the misdetection region identifier 112 to determine whether the object detection model 106 accurately detects the target object.

In some examples, the processor 104 may determine the misdetection region 114 based on an accuracy threshold. In some examples, an interquartile range (IQR) may be used to determine whether a region of the evaluation image dataset 110 is a misdetection region 114. The IQR may be defined as follows:

IQR=Q₃−Q₁ (1)

where Q₃ is the value of the 75th percentile of the accuracy scores of the grid cells, and Q₁ is the value of the 25th percentile of the accuracy scores of the grid cells.

An accuracy threshold may be a threshold lower bound. In some examples, the threshold lower bound may be defined based on the IQR. In some examples, the threshold lower bound may be defined as

Lower_Bound=Q₁−1.5IQR. (2)

A misdetection region 114 may be a location in the images of the evaluation image dataset 110 where the accuracy score (Xᵢ) of a given cell is less than the lower bound.

The processor 104 may implement a training image dataset generator 116 to generate a training image dataset 118. In some examples, the training image dataset 118 may be used to adjust the object detection model 106 based on an identified misdetection region 114. It should be noted that the misdetection region 114 may be present due to a weakness in training the object detection model 106 for the presence of a target object in the misdetection region 114. To adjust the object detection model 106, the training image dataset 118 may include images of a target object in the misdetection region 114. The object detection model 106 may then be trained using the training image dataset 118.

The training image dataset generator 116 may determine placement of a target object in the training image dataset 118 based on the misdetection region 114 in the evaluation image dataset 110. In some examples, the training image dataset 118 may include images with a target object placed in the misdetection region 114. For example, the training image dataset generator 116 may determine the grid that was used to generate the evaluation image dataset 110. The training image dataset generator 116 may position the target object in a cell of the grid identified as the misdetection region 114.

The training image dataset generator 116 may select a background image for the training image dataset 118. In some examples, one background may be selected for the training image dataset 118. The background may be a solid color, a color gradient, or an image. In some examples, multiple backgrounds may be selected for multiple subsets of images in the training image dataset 118.

In some examples, the background may be divided into the grid. The grid may correspond to the grid used to generate the evaluation image dataset 110. In other words, the same dimensions used for the grid of the evaluation image dataset 110 may be used for the grid of the training image dataset 118.

A target object used for the training image dataset 118 may be the same as or different from the target object used for the evaluation image dataset 110. In some examples, the target object may be loaded from an image database and sized to fit within the grid cell of the training image dataset 118.

A number of images may be rendered with the target object located at the misdetection region 114. For example, the training image dataset generator 116 may combine the target object and the background image to generate an image for the training image dataset 118. In some examples, different backgrounds may be used for a given target object. For instance, the training image dataset generator 116 may vary the background by selecting different background images and/or rotating a given background image for multiple images. By rotating and/or changing the background images, the object detection model 106 may be trained to handle variations in the background, thus providing object detection model adaptability.

In some examples, different target objects may be used for the same background. For example, the training image dataset generator 116 may load different target object images from an image database. The target object images may be resized to the dimension of a grid cell and placed into one or multiple specific locations of the background images based on the misdetection region 114.

In some examples, the training image dataset 118 may include images from the evaluation image dataset 110. For example, the training image dataset generator 116 may produce images in the evaluation image dataset 110 with the target object located in the misdetection region 114 as part of the training image dataset 118.

In some examples, the training image dataset generator 116 may record ground truth information about the target object in the training image dataset 118. For example, the training image dataset generator 116 may record a position of the target object in the training image dataset 118 as a ground truth bounding box. The ground truth information may be used to train the object detection model 106 to detect the target object in the misdetection region 114.

The processor 104 may update the object detection model 106 using the training image dataset 118. For example, the processor 104 may train the object detection model 106 using the images from the training image dataset 118. In some examples, the processor 104 may perform transfer learning to train the object detection model 106 with the training image dataset 118. With transfer learning, the original training of the object detection model 106 may be maintained and adjusted with additional training with the training image dataset 118 to correct for weaknesses in the object detection model 106 that result in the misdetection region 114.

In some examples, after the object detection model 106 is trained with the training image dataset 118, the processor 104 may repeat the evaluation stage to obtain an updated evaluation result. For example, the misdetection region identifier 112 may run the existing evaluation image dataset 110 or a new evaluation image dataset 110 on the object detection model 106 to decide whether another adjustment process is to be performed. For example, the misdetection region identifier 112 may determine whether the object detection model 106 detects a target object within a threshold amount of accuracy.

The described examples provide a streamlined approach for object detection model evaluation and adjustment. These examples provide for automated generation of an evaluation image dataset 110 and/or a training image dataset 118. These examples provide more specific information about weaknesses in the object detection model 106 than object detection model metrics such as mAP. With a continuous adjustment cycle, the described examples may help the object detection model 106 achieve or exceed expected performance. Because the process is streamlined end-to-end, additional labor resources to complete data labeling for datasets may be avoided, thus reducing expenses and time to adjust the object detection model 106.

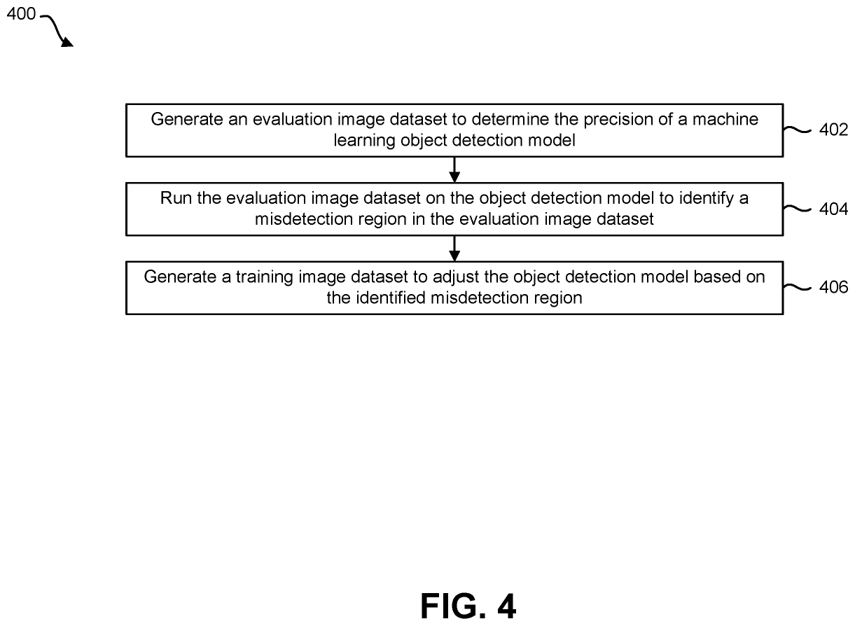

FIG. 4 is a flow diagram illustrating an example of a method 400 for object detection model evaluation and adjustment. The method 400 and/or an element or elements of the method 400 may be performed by an electronic device. For example, an element or elements of the method 400 may be performed by the electronic device 102 described in FIG. 1 and/or the processor 104 described in FIG. 1 any of which may be referred to generally as an “electronic device” in FIG. 4.

At 402, the electronic device may generate an evaluation image dataset to determine precision of a machine learning object detection model. For example, the electronic device may divide a background image (e.g., a solid color or image) into a grid.

In some examples, the electronic device may generate the evaluation image dataset based on placement of a target object within the grid of cells. The electronic device may place a target object into a cell of the grid. The electronic device may size the target object to fit within a cell of the grid. The evaluation image dataset may include multiple images with the target object placed in a different cell of the grid for each of the multiple images.

At 404, the electronic device may run the evaluation image dataset on the object detection model to identify a misdetection region in the evaluation image dataset. In some examples, the misdetection region may be a portion of the evaluation image dataset in which the object detection model fails to accurately detect a target object. In some examples, the misdetection region may be determined based on whether the object detection model fails to detect the target object with an accuracy score that is greater than a threshold accuracy score. In some examples, the threshold accuracy score may be determined based on the IQR of grid cells. If the accuracy score for a given cell is less than a threshold lower bound, then the electronic device may designate that grid cell as a misdetection region.

At 406, the electronic device may generate a training image dataset to adjust the object detection model based on the identified misdetection region. For example, the electronic device may determine the placement of a target object in the training image dataset based on the misdetection region in the evaluation image dataset. In some examples, the electronic device may determine a grid used to generate the evaluation image dataset. The electronic device may then position the target object in a cell of the grid identified as the misdetection region. The electronic device may select a background image for the training image dataset. The electronic device may combine the target object and the background image to generate an image for the training image dataset. In some examples, the electronic device may perform transfer learning to train the object detection model with the training image dataset.

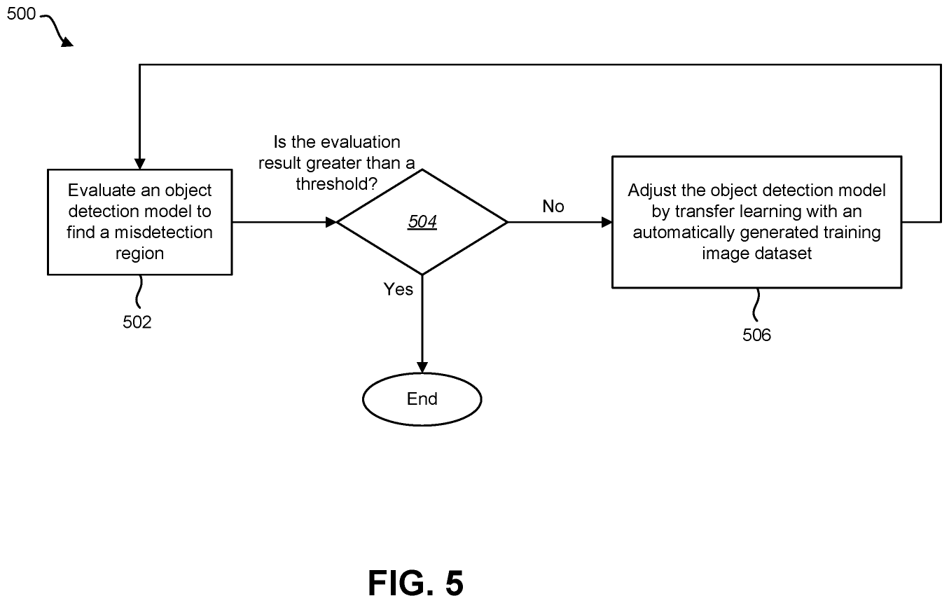

FIG. 5 is a flow diagram illustrating another example of a method 500 for object detection model evaluation and adjustment. The method 500 and/or an element or elements of the method 500 may be performed by an electronic device. For example, an element or elements of the method 500 may be performed by the electronic device 102 described in FIG. 1 and/or the processor 104 described in FIG. 1, any of which may be referred to generally as an “electronic device” in FIG. 5.

At 502, the electronic device may evaluate an object detection model to find a misdetection region. For example, the electronic device may run an evaluation image dataset on the object detection model. The evaluation image dataset may include a target object placed in different grid cells on a background. The electronic device may obtain an evaluation result for the object detection model. For example, the electronic device may determine accuracy scores for how the object detection model detects the target object within the grid cells.

At 504, the electronic device may determine whether the evaluation result is greater than a threshold. For example, the electronic device may determine whether any grid cell has an accuracy score less than a threshold lower bound. This grid cell may be designated as a misdetection region.

At 506, if the electronic device determines that the evaluation result is less than a threshold, then the electronic device may adjust the object detection model by transfer learning with an automatically generated training image dataset. The electronic device may generate the training image dataset by placing the target object at the misdetection region.

Upon training the object detection model with the training image dataset, the electronic device may, at 502, evaluate the object detection model again. If the electronic device determines, at 504, that the evaluation result is greater than a threshold, then the method 500 may end. Otherwise, the electronic device may again adjust, at 506, the object detection model with a generated training image dataset.

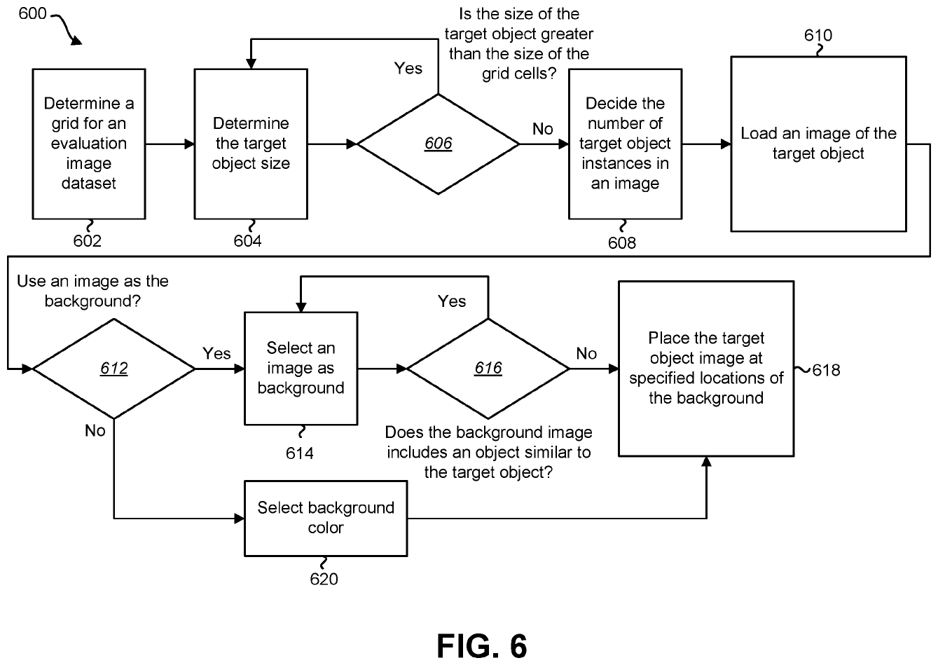

FIG. 6 is a flow diagram illustrating an example of a method 600 for generating an evaluation image dataset. The method 600 and/or an element or elements of the method 600 may be performed by an electronic device. For example, an element or elements of the method 600 may be performed by the electronic device 102 described in FIG. 1 and/or the processor 104 described in FIG. 1, any of which may be referred to generally as an “electronic device” in FIG. 6.

At 602, the electronic device may determine a grid for the evaluation image dataset. For example, the electronic device may determine the number of cells (e.g., the number of rows and columns in the grid). The electronic device may also determine the size (e.g., the height and width) of the grid cells.

At 604, the electronic device may determine the target object size. For example, the electronic device may determine the number of pixels for the target object. In some examples, the electronic device may determine the percentage of the evaluation image that will be occupied by the target object. In some examples, the percentage may be determined in terms of height and/or width of the target object as compared to the total height and/or width of the evaluation image.

At 606, the electronic device may determine whether the size of the target object is greater than the size of the grid cells. For example, the electronic device may determine whether the height and/or width of the target object exceed the height and/or width of a grid cell. If the electronic device determines that the size of the target object is greater than the size of the grid cells, then the electronic device may, at 604, determine the target object size again.

If the electronic device determines that the target object is not greater than the size of the grid cells, then, at 608, the electronic device may determine the number of target object instances. For example, the electronic device may select one instance of a target object to include in the images of the evaluation image dataset. In some examples, the electronic device may select two instances of a target object to include in the images of the evaluation image dataset, and so forth.

At 610, the electronic device may load an image of the target object. For example, the electronic device may load a target object image from an image database. In some examples, the image database may be self-maintained on the electronic device or a local server. In some examples, the image database may be an open image database (e.g., accessible to the public via the internet). The electronic device may resize the target object image to the size determined at 604.

At 612, the electronic device may determine whether to use an image as a background. If the electronic device selects to use an image as a background, then the electronic device may select, at 614, a given image as a background. For example, the electronic device may load a background image from an image database. In some examples, the electronic device may resize the background image to fit the grid.

At 616, the electronic device may determine whether the background image includes an object similar to the target object. For example, the background image may include metadata that describes objects in the background image. The target object image may also include metadata describing the target object. In some examples, the electronic device may compare the metadata of the target object image and the metadata of the background image to determine whether the background image includes an object similar to the target object. It should be noted that this analysis may be performed to ensure that the object detection model does not identify an object that is similar to the target object as the ground truth of the object in the background image may be unknown. In other words, to evaluate the performance of the object detection model, better results may be obtained if the object detection model is detecting the selected target object and not objects in the background image. If the electronic device determines that the background image includes an object similar to the target object, then the electronic device may select, at 614, another background image.

However, if the electronic device determines that the background image does not include an object similar to the target object, then the electronic device may, at 618, place the target object image at specified locations of the background. For example, the electronic device may place the selected number of target object instances in a grid cell. The electronic device may render and store a given evaluation image that combines the background and the target object. In some examples, the electronic device may repeat this process of placing the target object in different grid cells on the background until the possible combinations of target object placement in grid cells are exhausted. The rendered images may form the evaluation image dataset.

In some examples, the electronic device may record the location of the target object as ground truth data. For example, the electronic device may record the location of a target object in a given evaluation image as a ground truth bounding box. The ground truth data may be saved as metadata of the given evaluation image.

Returning to 612, if the electronic device determines that an image is not to be used for the background, then the electronic device may, at 620, select a background color. For example, the electronic device may select a solid color (e.g., red, green, blue, white, black, grey, etc.) for the background. In some examples, the electronic device may generate a gradient of a color for the background. The electronic device may then generate, at 618, the evaluation images for the evaluation image dataset by placing the target object on the background.

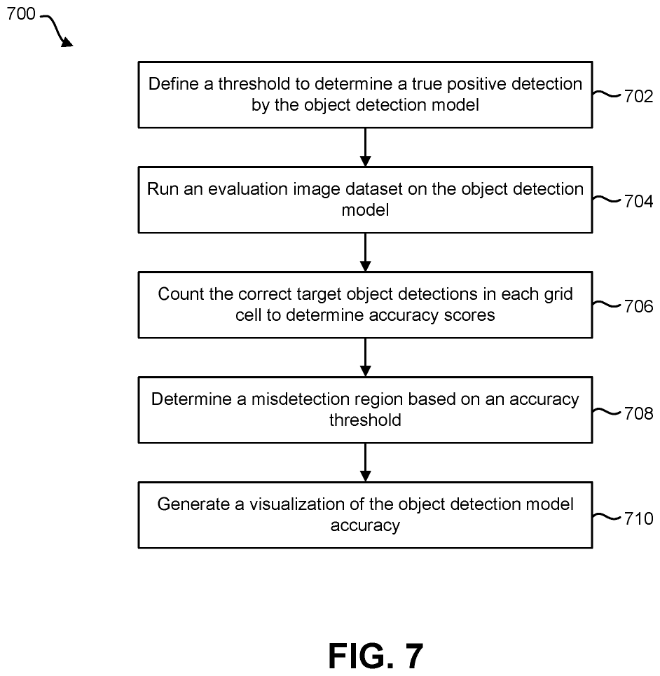

FIG. 7 is a flow diagram illustrating an example of a method 700 for evaluating an object detection model. The method 700 and/or an element or elements of the method 700 may be performed by an electronic device. For example, an element or elements of the method 700 may be performed by the electronic device 102 described in FIG. 1 and/or the processor 104 described in FIG. 1, any of which may be referred to generally as an “electronic device” in FIG. 7.

At 702, the electronic device may define a threshold to determine a true positive detection by the object detection model. For example, the electronic device may determine an Intersection over Union (IoU) threshold. In some examples, the IoU value may be a value used to measure the overlap of a predicted bounding box versus a ground truth bounding box for a target object. The closer the predicted bounding box value is to the ground truth bounding box value, the greater the intersection, which results in a greater IoU value.

The IoU threshold may be used to differentiate between a true positive detection by the object detection model and a false positive detect. For example, if the IoU value for a given target object detection is equal to or greater than the IoU threshold, then the electronic device may designate the target object detection a true positive. However, if the IoU value for a given target object detection is less than the IoU threshold, then the electronic device may designate the target object detection a false positive. It should be noted that the IoU threshold may be selected based on a desired level of accuracy in the object detection model. For instance, a high IoU threshold may be selected for use cases where high accuracy is desired. A low IoU threshold may be selected for use cases where low accuracy in the object detection model is acceptable.

At 704, the electronic device may run an evaluation image dataset on the object detection model. The object detection model may predict the presence of a target object in the evaluation images of the evaluation image dataset. For example, the object detection model may generate a predicted bounding box around a detected target object.

At 706, the electronic device may count the correct target object detections in each grid cell to determine accuracy scores. For example, the electronic device may use ground truth data recorded in the evaluation image dataset to determine whether the predicted object detection was a true positive or true negative detection. In the case of a positive detection, the electronic device may compare the IoU value to the IoU threshold to determine if the positive detection is a true positive or false positive.

At 708, the electronic device may determine a misdetection region based on an accuracy threshold. In some examples, the accuracy threshold may be defined according to Equation 2, where the accuracy for a given grid cell is based on the IQR of the grid and the accuracy score of the given grid cell. If the accuracy score of a given grid cell is less than the accuracy threshold, then the given grid cell may be determined to be a misdetection region. In other words, the electronic device may designate a given grid cell as a misdetection region if the object detection model does not have an acceptable ability to detect target objects in the given grid cell.

At 710, the electronic device may generate a visualization of the object detection model accuracy. For example, the electronic device may generate a heatmap or other visual display of the object detection model accuracy for human analysis. The visualization may be based on the accuracy statistics for the evaluation image dataset.

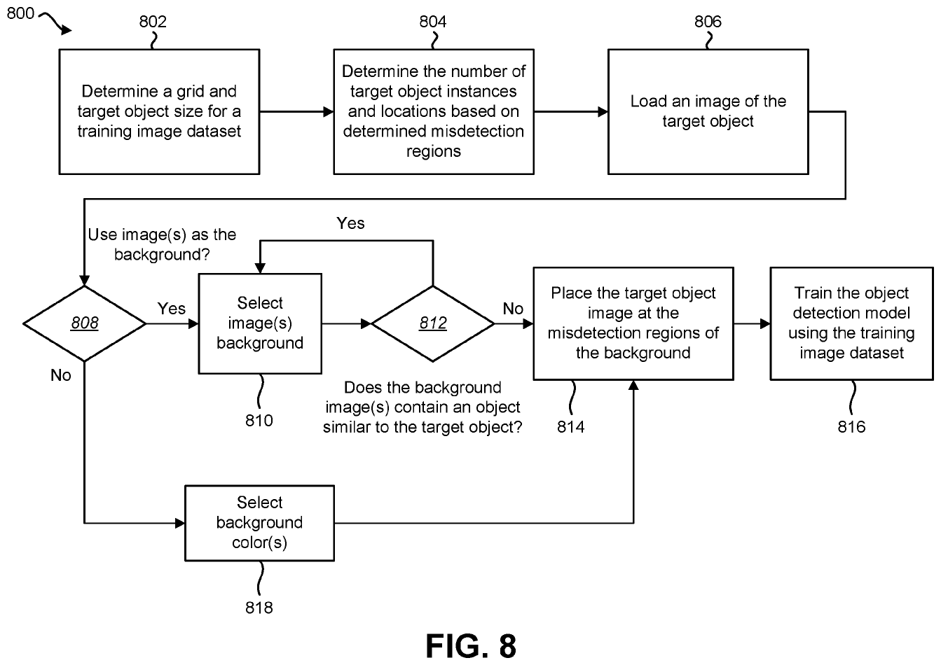

FIG. 8 is a flow diagram illustrating an example of a method 800 for generating a training image dataset. The method 800 and/or an element or elements of the method 800 may be performed by an electronic device. For example, an element or elements of the method 800 may be performed by the electronic device 102 described in FIG. 1 and/or the processor 104 described in FIG. 1, any of which may be referred to generally as an “electronic device” in FIG. 8.

At 802, the electronic device may determine a grid and target object size for the training image dataset. For example, the electronic device may apply the same configuration of grid cells, number of target object instances, and/or target object size as was used in the evaluation image dataset, as described in FIG. 6.

At 804, the electronic device may determine the number of target object instances and locations based on determined misdetection regions. For example, the electronic device may determine which grid cells are designated as misdetection regions based on the object detection model evaluation, as described in FIG. 7.

At 806, the electronic device may load an image of the target object. For example, the electronic device may load a target object image from an image database. In some examples, the image database may be self-maintained on the electronic device or a local server. In some examples, the image database may be an open image database (e.g., accessible to the public via the internet). The electronic device may resize the target object image to the size determined at 802.

At 808, the electronic device may determine whether to use an image as a background. In some examples, the electronic device may determine that a single image is to be used for the background. In some examples, the electronic device may determine that multiple images are to be used for backgrounds.

If the electronic device determines to use an image as a background, then the electronic device may select, at 810, a given image as a background. For example, the electronic device may load a background image from an image database. In some examples, the electronic device may resize the background image to fit the grid.

At 812, the electronic device may determine whether the background image includes an object similar to the target object. For example, the background image may include metadata that describes objects in the background image. The electronic device may compare the metadata of the target object image and the metadata of the background image to determine whether the background image includes an object similar to the target object, as described in FIG. 6. If the electronic device determines that the background image includes an object similar to the target object, then the electronic device may select, at 810, a replacement background in response to determining that the background image contains an object similar to the target object.

However, if the electronic device determines that the background image does not include an object similar to the target object, then the electronic device may, at 814, place the target object image at the misdetection regions of the background. The electronic device may render a given training image that combines the background and the target object. In some examples, the electronic device may rotate the background and/or select, at 810, a new background image. In some examples, the electronic device may then repeat, at 814, the process of placing the target object in a misdetection region on the background until the possible combinations of target object placement are exhausted.

In some examples, the electronic device may record the location of the target object as ground truth data. For example, the electronic device may record the location of a target object in a given training image as a ground truth bounding box. The ground truth data may be saved as metadata of the given training image.

Returning to 808, if the electronic device determines that an image is not to be used for the background, then the electronic device may select 818 a background color. For example, the electronic device may select a solid color (e.g., red, green, blue, white, black, grey, etc.) for the background. In some examples, the electronic device may generate a gradient of a color for the background. The electronic device may then generate, at 814, the training images for the training image dataset by placing the target object in a misdetection region on the background.

At 816, the electronic device may train the object detection model using the training image dataset. For example, the electronic device may perform transfer learning on the object detection model using the training image dataset.

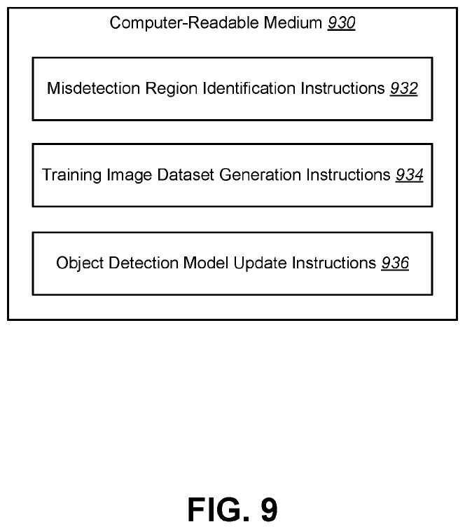

FIG. 9 is a block diagram illustrating an example of a computer-readable medium 930 for object detection model evaluation and adjustment. The computer-readable medium 930 may be a non-transitory, tangible computer-readable medium 930. The computer-readable medium 930 may be, for example, RAM, EEPROM, a storage device, an optical disc, and the like. In some examples, the computer-readable medium 930 may be volatile and/or non-volatile memory, such as DRAM, EEPROM, MRAM, PCRAM, memristor, flash memory, and the like. In some examples, the computer-readable medium 930 described in FIG. 9 may be an example of memory for an electronic device described herein. In some examples, code (e.g., data and/or executable code or instructions) of the computer-readable medium 930 may be transferred and/or loaded to memory or memories of the electronic device. It should be noted that the term “non-transitory” does not encompass transitory propagating signals.

The computer-readable medium 930 may include code (e.g., data and/or executable code or instructions). For example, the computer-readable medium 930 may include misdetection region identification instructions 932, training image dataset generation instructions 934, and object detection model update instructions 936.

In some examples, the misdetection region identification instructions 932 may be instructions that when executed cause the processor of the electronic device to run an evaluation image dataset on an object detection model to identify a misdetection region in the evaluation image dataset. In some examples, this may be accomplished as described in FIG. 1.

In some examples, the training image dataset generation instructions 934 may be instructions that when executed cause the processor of the electronic device to generate a training image dataset to adjust the object detection model based on the identified misdetection region. In some examples, this may be accomplished as described in FIG. 1. For example, the processor may determine placement of a target object in the training image dataset based on the misdetection region in the evaluation image dataset.

In some examples, the processor may determine a grid used to generate the evaluation image dataset. The processor may position the target object in a cell of the grid identified as the misdetection region. The processor may select a background image for the training image dataset. The processor may then combine the target object and the background image to generate an image for the training image dataset. In some examples, the processor may record a position of the target object in the training image dataset as a ground truth bounding box.

In some examples, the object detection model update instructions 936 may be instructions that when executed cause the processor of the electronic device to update the object detection model using the training image dataset. For example, the processor may perform transfer learning to train the object detection model with the training image dataset. In some examples, this may be accomplished as described in FIG. 1.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be within the scope of the disclosure. For example, operations, functions, aspects, or elements of the examples described herein may be omitted or combined.

1. An electronic device, comprising:
a processor to:
generate an evaluation image dataset to determine precision of a machine learning object detection model;
run the evaluation image dataset on the object detection model to identify a misdetection region in the evaluation image dataset; and
generate a training image dataset to adjust the object detection model based on the identified misdetection region.

2. The electronic device of claim 1, wherein the misdetection region comprises a portion of the evaluation image dataset in which the object detection model fails to accurately detect a target object.

3. The electronic device of claim 1, wherein the processor to generate the evaluation image dataset comprises the processor to:
divide a background image into a grid; and
place a target object into a cell of the grid.

4. The electronic device of claim 3, wherein the evaluation image dataset comprises a first image with the target object placed in a first cell of the grid and a second image with the target object placed in a second cell of the grid.

5. The electronic device of claim 1, wherein the processor to generate the evaluation image dataset further comprises the processor to size a target object to fit within a cell of a grid.

6. An electronic device, comprising:
memory to store a background image; and
a processor to:
determine a grid of cells to divide the background image;
generate an evaluation image dataset based on a placement of a target object within the grid of cells;
run the evaluation image dataset on an object detection model to identify a misdetection region in the evaluation image dataset; and
generate a training image dataset to adjust the object detection model based on the identified misdetection region.

7. The electronic device of claim 6, wherein the processor is to:
load the target object from an image database;
determine a size of the target object to be placed in a cell of the background image; and
adjust the target object to the determined size.

8. The electronic device of claim 6, wherein the processor to generate the evaluation image dataset comprises the processor to:
place the target object in a first cell of the background image;
place the target object in a second cell of the background image;
render a first image for the first target object placement; and
render a second image for the second target object placement.

9. The electronic device of claim 6, wherein the processor is to:
determine that the background image contains an object similar to the target object; and
select a replacement background in response to determining that the background image contains an object similar to the target object.

10. The electronic device of claim 9, wherein the processor is to determine that the background image contains an object similar to the target object based on metadata of the background image and a target object image.

11. A non-transitory tangible computer-readable medium comprising instructions when executed cause a processor of an electronic device to:
find a blind spot in an object detection model;
generate a training image dataset having a target object positioned in a cell of the blind spot; and
update the object detection model by transfer learning using the training image dataset.

12. The non-transitory tangible computer-readable medium of claim 11, wherein the instructions to generate the training image dataset comprise instructions that when executed cause the processor to:
determine placement of the target object in the training image dataset based on a misdetection region in an evaluation image dataset.

13. The non-transitory tangible computer-readable medium of claim 11, wherein the instructions when executed cause the processor to:
determine a grid used to generate an evaluation image dataset;
select a background image for the training image dataset; and
combine the target object and the background image to generate an image for the training image dataset.

14. The non-transitory tangible computer-readable medium of claim 11, wherein the instructions when executed cause the processor to:
record a position of the target object in the training image dataset as a ground truth bounding box.

15. The non-transitory tangible computer-readable medium of claim 11, wherein the instructions when executed cause the processor to:
perform the transfer learning to train the object detection model with the training image dataset.
